(19) United States
(12) Patent Application Publication
(10) Pub. No.: US 2022/0264171 A1
(43) Pub. Date: Aug. 18, 2022

(54) Use of In-Band Data to Facilitate Ad Harvesting for Dynamic Ad Replacement

(71) Applicant: Roku, Inc., San Jose, CA (US)

(72) Inventors: Alejandro Gutierrez, Dallas, TX (US); John E. Sormark, Redwood City, CA (US); Shashank C. Merchant, Sunnyvale, CA (US); Brian P. Jentz, Buxton (GB); John L. Haynes, III, Sandy, UT (US)

(21) Appl. No.: 17/303,704

(22) Filed: Jun. 4, 2021

Related U.S. Application Data
(60) Provisional application No. 63/200,090, filed on Feb. 12, 2021.

(51) Int. Cl. H04N 21/262; H04N 21/81; H04N 21/234; H04N 21/433

(52) U.S. Cl. CPC H04N 21/26266; H04N 21/26275; H04N 21/4331; H04N 21/26241; H04N 21/23424; H04N 21/812

(57) ABSTRACT

A method and system for harvesting ads or other modifiable-content segments for use to facilitate dynamic ad replacement or other dynamic content modification. An example method includes (i) determining, based on data carried in-band with a media stream being distributed, a time position of an ad in the media stream, (ii) using the determined time position of the ad in the media stream as a basis to select, from reference fingerprints representing the media stream, a set of the reference fingerprints that represent the ad in the media stream, and (iii) populating the selected set of reference fingerprints into an ad-inventory database as a set of fingerprints representing the ad, to facilitate later detecting presence of another instance of the same ad in the media stream or in another media stream and, based on the later detecting, dynamically replacing the detected other instance of the ad.

### REFERENCE TO RELATED APPLICATIONS

This application claims priority to U.S. Provisional Patent Application No. 63/200,090, filed Feb. 12, 2021, the entirety of which is hereby incorporated by reference.

### BACKGROUND

In a typical linear broadcast system, a producer or other provider of audio and/or video media content transmits a linear media stream representing the media content to one or more media distribution points, and each media distribution point in turn transmits the media stream to various end-user media clients for presentation. By way of example, a national television (TV) broadcaster in the United States may provide a digital television broadcast feed carrying a media stream to various multi-channel video program distributors (MVPD), such as cable or satellite TV head-ends, that serve respective market areas throughout the country, and each MVPD may in turn transmit the media stream to various end-user reception devices, such as set top boxes and/or TVs, in the MVPD's market area for playout to end users.

The media stream of such a broadcast feed could include both program content and ad content. For instance, the media stream could include television programming with interspersed commercial breaks, and each commercial break could include one or more ads. As the media stream gets distributed ultimately to end-user devices, the end-user devices could thus play out both the program content and the interspersed ads.

### SUMMARY

A dynamic ad replacement (or “dynamic ad insertion” (DAI)) system can operate to facilitate dynamic replacement of certain ads in such a media stream, so that when an end-user device plays out the media stream, the device would play out a replacement ad in place of an originally included ad. The system could thereby help tailor advertisements to a particular market, consumer or the like.

Such a system could be configured to facilitate dynamic ad replacement at various points in the media distribution path. By way of example, the system could operate at or in association with an MVPD, to facilitate replacement of national ads with local ads specific to the MVPD's local market area, so that end-user devices served by the MVPD would play out more-locally-relevant ads in place of the national ads. And as another example, the system could operate at or in association with end-user devices, perhaps as a cloud-based system that engages in broadband control communication with the end-user devices, to facilitate targeted ad replacement based on user demographics or the like.

A representative dynamic ad replacement system could make use of digital fingerprinting technology to identify the presence of an ad within a linear media stream and to coordinate replacement of that identified ad.

In practice, the media stream at issue could define a sequence of frames of media content (e.g., digital video frames) that an end-user device could process for presentation to a user. Over the course of the media stream, subsequences of those frames would thus represent program content and other subsequences of the frames would represent interspersed ads.

To facilitate dynamic ad replacement, the example system could have access to an ad-inventory database that contains digital fingerprints respectively representing the frames of each of various ads. For instance, for each such ad, the database could contain a sequence of digital fingerprints representing the sequence of frames of the ad and could correlate that set of fingerprints with a unique identifier of the ad and perhaps with other associated metadata.

In real-time as the media stream is being distributed, a fingerprint-generation engine operating at or in association with a linear TV broadcast head-end (e.g., MVPD) or other point in the media distribution path could regularly generate digital reference fingerprints representing the media stream. Namely, for each frame of the media stream being distributed, the engine could programmatically generate a reference fingerprint that represents the frame. And as the engine generates this sequence of reference fingerprints, the engine could store the generated reference fingerprints, with associated frame timestamps and/or other information, in a reference database.

Further, in real-time as the engine is generating and storing these digital reference fingerprints representing frames of the media stream, a fingerprint-matching server could compare the generated digital reference fingerprints with the digital ad fingerprints in the ad-inventory database. And if and when the fingerprint-matching server detects with sufficient confidence that a subsequence of the generated digital reference fingerprints matches a subsequence (e.g., starting subsequence) of the digital ad fingerprints representing a given ad, the fingerprint-matching server could output a trigger for dynamic replacement of the detected ad in the media stream.

In an example where dynamic ad replacement would occur at the MVPD, the output trigger could cause a server operating at or in association with the MVPD to dynamically replace the ad. For instance, starting at the frame of the media stream matching the first frame of the detected ad, the server could substitute frames of the media stream, i.e., frames of the detected ad, with frames of a replacement ad. As the modified media stream then passes to end-user devices served by the MVPD, those devices would therefore play out the replacement ad instead of the detected underlying ad.

Alternatively, in an example where dynamic ad replacement would occur at an end-user device such as a set top box or TV, the output trigger could cause a server to engage in signaling with the end-user device, to invoke the ad replacement. This signaling between the server and the end-user device could occur over a broadband connection and could take advantage of a several-second delay in the transmission of the media stream to the end-user device. Namely, with broadband communication during that delay, the server could give the end-user device advanced notice of the upcoming ad-replacement opportunity in the media stream that the end-user device is processing for presentation, so the end-user device could have enough time to prepare for and carry out the ad replacement at the appropriate time in the media stream.

Through this signaling, the server could inform the end-user device of an upcoming time point (e.g., frame timestamp) where the underlying ad starts in the media stream, and could direct the end-user device to replace the ad with a replacement ad. Further, through this signaling, the server could provide the end-user device with a set of the reference fingerprints leading up to and through the underlying ad. And the end-user device could then generate query fingerprints of the media stream being processed and could match those generated query fingerprints with the provided reference fingerprints, to help identify the time point where the end-user device should start the ad replacement and perhaps also to help ensure that media stream continues to the be the same media stream (e.g., that no channel change occurs), as a condition for the end-user device starting and/or continuing with the dynamic ad replacement.

One technical issue with these or other such dynamic ad replacement systems and processes is how to populate the ad-inventory database in the first place with the sets of digital fingerprints representing various ads, so as to enable a fingerprint-matching server to make use of those digital ad fingerprints as a basis to detect the presence of ads in media streams.

One way to accomplish this is for ad-programmers to provide copies of the ads, perhaps as MP4 video files, and to have a fingerprint-generation engine generate for each received ad the set of digital fingerprints representing frames of the ad and store that generated set of ad fingerprints in the ad-inventory database along with associated metadata.

Unfortunately, however, that process could be both laborious and error prone.

The present disclosure provides an improved technical mechanism to help address this issue. In accordance with the disclosure, a computing system will harvest ads by detecting the presence of the ads in one or more media streams being distributed and by storing in the ad-inventory database the corresponding reference fingerprints generated from the media stream(s).

To facilitate this, the computing system could make use of ad-demarcation data, such as data in accordance with the Society of Cable and Telecommunications Engineers (SCTE) standards, e.g., SCTE 104, SCTE 224, and/or SCTE 35, that is carried in or with some such media streams. Namely, the computing system could read such SCTE data or the like to determine that an ad starts and ends at particular time points in a media stream being distributed. And based on that information, the computing system could deem, as the fingerprints representing the ad, the reference fingerprints that represent the frames of that media stream extending from the determined start time to the determined end time. The computing system could then take a copy of those particular reference fingerprints and store them in the ad-inventory database as the set of fingerprints representing the ad, along with associated ad-metadata that the computing system may also extract from the SCTE data or/or may obtain from other associated records such as a programming schedule or the like.

Having thus harvested an ad into the ad-inventory database, a dynamic ad replacement system could then make use of the ad fingerprints as a basis to later detect presence of another instance of the same ad in the same media stream or in another media stream, to facilitate dynamic ad replacement as discussed above for instance.

These as well as other aspects, advantages, and alternatives will become apparent to those of ordinary skill in the art by reading the following detailed description, with reference where appropriate to the accompanying drawings. Further, it should be understood that the descriptions provided in this summary and below are intended to illustrate the invention by way of example only and not by way of limitation.

### BRIEF DESCRIPTION OF THE DRAWINGS

FIG. 1 is a simplified block diagram of an example system in which various disclosed principles can be applied.

FIG. 2 is another simplified block diagram of an example system in which various disclosed principles can be applied.

FIG. 3 is a flow chart depicting a method that could be carried out in accordance with the disclosure.

FIG. 4 is a simplified block diagram of an example computing system that could operate in accordance with the disclosure.

FIG. 5 is a simplified block diagram of an example media client that could operate in accordance with the disclosure.

### DETAILED DESCRIPTION

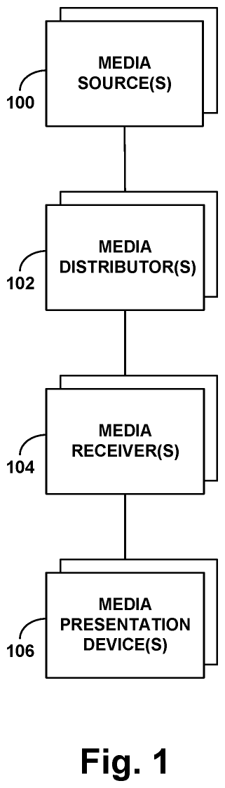

Referring to the drawings, FIG. 1 is a simplified block diagram of an example system in which various disclosed principles can be applied. It will be understood, however, that this and other arrangements and processes described herein can take various other forms. For instance, elements and operations can be re-ordered, distributed, replicated, combined, omitted, added, or otherwise modified. Further, it will be understood that functions described herein as being carried out by one or more entities could be implemented by and/or on behalf of those entities, through hardware, firmware, and/or software, such as by one or more processing units executing program instructions or the like.

As shown in FIG. 1, the example system includes one or more media sources 100 (e.g., broadcasters, web servers, etc.), one or more media distributors 102 (e.g., multi-channel distributors, such as cable providers, satellite providers, over-the-air broadcast providers, web aggregators, etc.), one or more media receivers 104 (e.g., cable receivers, satellite receivers, over-the-air broadcast receivers, computers or other streaming media receivers, etc.), and one or more media presentation devices 106 (e.g., televisions or other display devices, loudspeakers or other audio output devices, etc.)

Without limitation, the media sources 100 could be national broadcasters, such as ABC, NBC, CBS, FOX, HBO, and CNN, or any of various streaming-channel providers, among other possibilities. Further, the media distributors 102 could be local affiliates and/or other local content distributors serving specific designated market areas (DMAs), or streaming-channel distributors such as Roku, Inc., or the like. And media receivers 104 and media presentation devices 106 could then be associated devices or applications, possibly situated at customer premises, such as homes or business establishments.

With this or other arrangements, the media sources 100 could deliver media streams to the media distributors 102 for distribution to receivers 104 at customer premises, and the media distributors 120 could distribute the media streams to the receivers 104 as particular channels of content (e.g., particular frequencies, particular streaming media sessions, or other defined channels). Each receiver 104 could then respond to user input or one or more other triggers by tuning to or otherwise starting to receive a selected channel and outputting to a media presentation device 106 the media stream of that channel. And the media presentation device 106 could receive and render that media stream (e.g., displaying or otherwise presenting content of the media stream) for consumption by one or more end users.

By way of example, a representative media presentation device 106 could be a television situated at customer premises, which could be coupled by an HDMI cable with a cable-TV set top box, and the set top box could be coupled through a local distribution network with a cable-TV head end that distributes media streams of various television channels provided by national and/or local broadcasters. In this arrangement, the television could regularly receive a media stream via HDMI from the set top box, and the set top box could tune to a particular channel from the head end in response to user input, so that the media stream arriving at the television would then be the media stream of the user-selected channel.

And as another example, a television situated at customer premises could alternatively be connected by an HDMI cable with a streaming-media receiver such as a ROKU brand digital media player, or a computer or other device, which could be in network communication with a streaming-media server of a virtual multichannel video program distributor (virtual-MVPD) that distributes various channels of content. In this arrangement, the television could regularly receive a media stream via HDMI from the streaming-media receiver, and the streaming-media receiver could work with the streaming-media server to cause the streaming-media server to deliver to the streaming-media receiver a particular user-selected channel, which the streaming-media receiver could output in its media stream to the television. Thus, here too, the media stream arriving at the television could likewise be the media stream of the user-selected channel.

As noted above, each of various such media streams could contain both program content and ad content. For instance, each such media stream could carry television programming, movies, or other media content with interspersed commercial breaks including ads. Further, it may be useful to implement DAI with respect to such media streams, to dynamically replace particular ads with replacement ads, possibly targeted to specific markets and/or end-users.

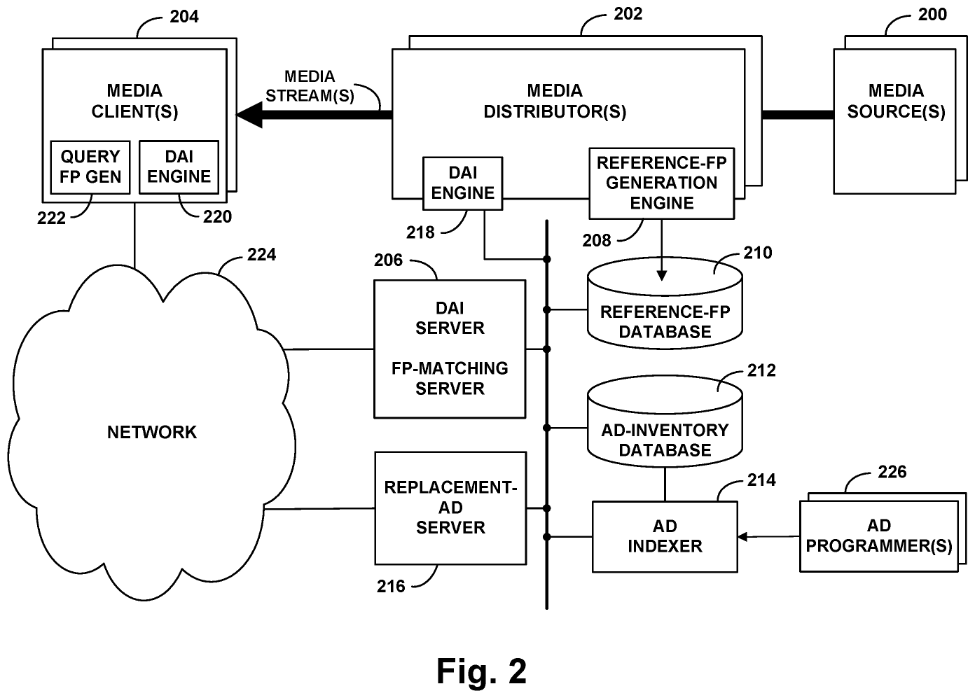

FIG. 2 illustrates more specifically an example system in which DAI or other such dynamic content modification could be implemented.

FIG. 2 shows at its top a representative media delivery system similar to that shown in FIG. 1, with media streams being provided by representative media sources 200 and distributed by representative media distributors 202 for distribution to media clients 204 such as receivers and/or media presentation devices, which might be at customer premises. Each of various such media streams could be a linear broadcast feed and/or a streaming media channel, among other possibilities, and various media clients 204 could receive such media streams directly or indirectly from various media distributors 202 through any of a variety of distribution channels, such as but not limited to cable, satellite, terrestrial over-the-air broadcast, broadband streaming, or others now known or later developed.

In an example implementation, the media content of each media stream could define a sequence of digital frames of media content (e.g., video frames, each being a respective image or the like) that media clients 204 could process to facilitate presentation to users. For instance, a media source 200, media distributor 202, and/or other entity might broadcast, stream, or otherwise provide such a sequence of frames encapsulated in a transport stream for receipt by receivers, and the receivers might receive the transport stream, extract the sequence of frames from the transport stream, and output the sequence of frames for receipt and rendering by media presentation devices.

Further shown in FIG. 2 are components of an example DAI system, which could operate to facilitate DAI as discussed herein.

As shown, without limitation, the example DAI system could include a DAI server 206, which could coordinate dynamic ad replacement and could include or interoperate with a fingerprint-matching server to facilitate fingerprint-matching. Further, the DAI system could include, perhaps respectively at each of various media distributors 202, a reference-fingerprint-generation engine 208, which could generate and provide reference fingerprints representing media streams that are en route to media clients 204. And the DAI system could include a reference-fingerprint database 210, which could store the generated reference fingerprints.

In addition, the DAI system could include an ad-inventory database 212, which could store fingerprints representing ads that are subject to dynamic replacement. And the DAI system could include an ad indexer 214, which could manage populating of the ad-inventory database 212 with replaceable-ad data. Further, the DAI system could include a replacement-ad server 216, which could serve replacement ads for insertion in place of replaceable ads.

In an example implementation, the DAI system could also include server-side components to facilitate dynamic ad replacement as to ads in media streams en route to media clients 204 and client-side components to facilitate dynamic ad replacement as to ads in media streams being processed for presentation. For instance, the DAI system could include, perhaps respectively at each of various media distributors 202, a DAI engine 218 that could carry out server-side dynamic ad replacement. And the DAI system could include, perhaps respectively at each of various media clients 204, a DAI engine 220 that could carry out client-side dynamic ad replacement, as well as a query-fingerprint-generation engine 222 that could generate query fingerprints of media content being processed for presentation.

As further shown in FIG. 2, each of various media clients 204 could be interconnected with a network 224 that provides connectivity with various server-side components such as the DAI server 208 and the replacement-ad server 216. For instance, each media client 204 could sit as a node on a local area network (LAN), having an assigned Internet Protocol (IP) address on the LAN and the LAN having an IP address on the network 224. And the various server-side components could be accessible at predefined addresses on network 224. Thus, each media client 204 could engage in data communication with various server-side components via the network 206 while the media client 204 is processing a media stream for presentation.

The example arrangement of FIG. 2 could implement server-side and/or client-side dynamic ad replacement as discussed above for instance, using fingerprint matching as a basis to detect the presence of a replaceable ad in a media stream, and then dynamically replacing that ad with a replacement ad.

To facilitate dynamic ad replacement, the example DAI system could regularly populate reference-fingerprint database 210 with reference fingerprint data. For instance, for each of one or more media streams being distributed by a media distributor 204, the reference-fingerprint-generation engine 208 could programmatically generate digital reference fingerprints on a per-frame basis or other ongoing basis and could establish for each such reference fingerprint associated metadata including for instance an identity of the media stream and a reference timestamp indicating a time point of the associated frame in the media stream. And the reference-fingerprint-generation engine 208 could provide these reference fingerprints and associated metadata for storage in the reference-fingerprint database 210 in a manner that allows ready searching and access.

An example digital fingerprinting process as to video content could involve establishing a unique representation of luminosity and/or other video characteristics per video frame. For instance, for each video frame, the reference-fingerprint-generation engine 208 could programmatically divide the frame into a grid, measure luminosity per grid cell, and generate as a digital reference fingerprint of the frame a bit string in which each bit or series of bits represents luminosity of a respective grid cell or represents a weighted difference between the luminosity of certain defined pairs of the grid cells, among other possibilities. Further, the reference-fingerprint-generation engine 208 could apply this process continually as to each frame, as to each key frame, periodically, or on another defined basis. Other digital fingerprinting processes could be used as well.

In addition, to facilitate dynamic ad replacement, the ad indexer 214 could populate the ad-inventory database 212 with digital fingerprints representing replaceable ads, i.e., ads that could be subject to dynamic replacement.

As noted above, one way to accomplish this is for the ad indexer 214 to receive copies of the ads, perhaps as MP4 video files, have a fingerprint-generation engine generate digital ad fingerprints representing frames of those video files, and store the generated ad fingerprints in the ad-inventory database 212. For example, the ad indexer 214 could receive these ad video files from ad programmers 226, along with associated metadata such as ad identification, duration, and description information. For each such received ad video file, the ad indexer 214 could then work with fingerprint-generation engine 208 or another fingerprint-generation engine, to generate digital ad fingerprints representing the sequence of video frames of the ad, and the ad indexer 214 could store each ad's generated sequence of ad fingerprints in the ad-inventory database 212 along with the associated metadata, in a manner that allows ready searching and access.

To carry out server-side DAI, as discussed above, DAI server 206 could regularly compare the fingerprints representing media streams en route to media clients 204 with the ad fingerprints representing replaceable ads, in an effort to find a match that indicates the presence of a replaceable ad in such a media stream. For instance, as reference fingerprints representing the frames of a given media stream that is being distributed by a given media distributor 202 are stored in the reference-fingerprint database 210, the DAI server 206 could search the ad-inventory database for a sequence of ad fingerprints that match a sequence of those reference fingerprints.

This fingerprint matching process could involve comparing corresponding portions of the fingerprints with each other to determine whether the portions match exactly or within defined tolerances. For example, the DAI server 206 could compute a maximum deviation between the fingerprints and determine if the maximum deviation is within a predefined tolerance. Further, if the fingerprints are binary, this could be a Boolean determination or could involve computing a Hamming distance (as a count of mismatches between respective bit locations in the fingerprints), and if the fingerprints are more complex values, such as decimal values or vectors (e.g., grey values per video frame region), this could involve determining a distance between the values or vectors. Other examples are possible as well.

Upon finding with sufficient certainty that the reference fingerprints of the given media stream match ad fingerprints of a replaceable ad, perhaps that a sequence of the reference fingerprints match a sequence of ad fingerprints at the start of the replaceable ad, the DAI server 206 could conclude that the ad represented by those ad fingerprints is present in the given media stream and could note from the reference-fingerprint data a timestamp of the ad.

Having detected the presence of a replaceable ad in the given media stream being distributed by the given media distributor 202, the DAI server 206 could then arrange for replacement of that ad in the given media stream. For instance, the DAI server 206 could engage in signaling with a given DAI engine 218 at the given media distributor 202 to note the presence of the replaceable ad and direct the given DAI engine 218 to replace the ad. And in response, the given DAI engine 218 could splice a replacement ad into the media stream in place of the replaceable ad, so that the media stream being distributed by the given media distributor 202 would carry the replacement ad in place of the replaceable ad. In practice, for instance, the given DAI engine 218 could obtain the replacement ad from the replacement-ad server, and the replacement ad might be targeted to a local market or customer base of the given media distributor 202.

This server-side DAI may require buffering of the media stream at the given media distributor 202 for a period of time sufficient to allow generation of the reference fingerprints representing frames of the media stream, matching of the generated reference fingerprints with the ad fingerprints, and processing of the ad replacement.

To carry out client-side DAI as discussed above, on the other hand, the DAI engine 220 at given media client 204 could interwork with the DAI server 204. In practice, for instance, this process could first involve identifying the media stream that the media client 204 is processing for presentation and could then involve the DAI server 206 performing processing as in the server-side implementation to detect a replaceable ad in that media stream. And the process could then involve the DAI server 206 directing the media client 204 to replace that ad with a replacement ad and the DAI engine 220 accordingly carrying out the ad replacement.

Identifying the media stream that the media client 204 is processing for presentation could take various forms.

For instance, the media client's DAI engine 220 may gain direct knowledge of the identity of the media stream that the media client 204 is processing for presentation, such as if the media client 204 is involved with selecting of that media stream to be presented, or by reading or otherwise ascertaining an identifier of the media stream from in-band data in the media stream or in a transport stream that carries the media stream. And the DAI engine 220 could then transmit that determined identity to the DAI server 206.

Alternatively, if the DAI engine 220 does not have knowledge of the identity of the media stream that the media client 204 is processing for presentation (e.g., if the media client is a TV that is merely receiving a media stream to be rendered, without an included identifier of the media stream), the DAI server 206 could engage in fingerprint-based processing to identify the media stream. For instance, as the media client 204 processes (e.g., receives, transcodes, renders, outputs, or otherwise processes) the media stream for presentation, the query-fingerprint-generation engine 222 could regularly generate digital query fingerprints representing frames of the media stream and could regularly transmit the generated query fingerprints to the DAI server 206 for analysis. And the DAI server 206 could compare those query fingerprints with reference fingerprints in the reference-fingerprint database 210 to find a match, which would indicate that the media stream represented by the matching reference fingerprints is the media stream being processed by the media client 204 for presentation.

Still alternatively, in a scenario where the media client 204 is receiving the media stream from a virtual-MVPD or other entity that has knowledge of the identity of the media stream being received by the media client 204, that virtual-MVPD or other entity could transmit an identity of that media stream to the DAI server 206, with an indication that the media client 204 is processing that media stream for presentation.

Once the DAI server 206 has determined in this or another manner the media stream that the media client 204 is processing for presentation, the DAI server 206 could then proceed as noted above to detect in that identified media stream the presence of a replaceable ad. For instance, the DAI server 206 could compare the reference fingerprints representing that identified media stream with the ad fingerprints in the ad-inventory database 212. And upon finding with sufficient certainty that ad fingerprints representing frames of a particular replaceable ad match reference fingerprints representing frames of the identified media stream, the DAI server 206 could conclude that that replaceable ad is present in the media stream being processed for presentation by the media client 204.

Further, the DAI server 206 could ascertain from reference-fingerprint metadata a timestamp indicating where the replaceable ad appears in the media stream, and the DAI server 206 could ascertain from the ad-fingerprint metadata various information about the replaceable ad.

Having detected the presence of the replaceable ad in the media stream being processed for presentation by the media client 204, the DAI server 206 could then arrange with the media client for replacement of that ad in the media stream. For instance, the DAI server 206 could transmit to the DAI engine 220 a directive for the DAI engine 220 to insert a replacement ad in place of the replaceable ad. In or with this directive, the DAI server 206 could specify the timing and other information about the replaceable ad, based on the ascertained metadata. And the DAI engine 220 could then work to obtain from the replacement-ad server 216 a replacement ad, perhaps targeted to a user of the media client 204, and could splice that replacement ad into the media stream in place of the replaceable ad, so that the media stream being processed for presentation by the media client 204 will include the replacement ad instead of the replaceable ad.

As with the server-side DAI process, this client-side DAI process may leverage a delay in distribution of the media stream from the media distributor 202 to the media client 204. This delay could be an inherent delay in transmission of the media stream along the media distribution path from the media distributor 202 to the media client and/or could include intentionally inserted delay to help facilitate this process or for other purposes. With this delay, as the media client 204 is processing the media stream for presentation, the DAI server 206 could inform the media client 204 of an upcoming replaceable ad before the media client 204 receives and/or processes that segment of the media stream for presentation, giving the media client 204 advanced notice of that ad-replacement opportunity and time to obtain and insert replacement ad content.

As noted above, the present disclosure provides for an improved mechanism to help populate the ad-inventory database 212 with ad fingerprints, to help facilitate DAI as discussed above, or for other purposes.

As indicated above, a computing system could harvest ads by detecting the presence of the ads in one or more media streams being distributed and by storing in the ad-inventory database 212 the corresponding reference fingerprints generated from the media stream(s). In a non-limiting example implementation, the computing system that carries out this harvesting could comprise the reference-fingerprint-generation engine 208 and the ad indexer 214. Though other arrangements could be possible as well, including any of a variety of client-side components and/or server-side (e.g., network/cloud-based) components, among other possibilities.

As further indicated above, to facilitate this process, the computing system could make use of ad-demarcation data carried in-band with some such media streams, such as SCTE data that is carried in or with the media streams. For instance, the computing system could read SCTE data to determine the start and end time points of an ad in a media stream being distributed. And based on that information, the computing system could obtain from the reference-fingerprint database 210 and store in the ad-inventory database 212 the reference fingerprints representing that determined portion of the media stream, along with associated metadata that the computing system may extract from the SCTE data and/or obtain from a programming schedule or other source.

In an example system, SCTE data demarcating an ad in a media stream could be carried in or with the media stream in various ways. For instance, the SCTE data could be carried in packet headers or special packets of a transport stream that carries the media stream. Or the SCTE data could be carried within the media payload itself, such as in the form of ancillary data (e.g., vertical ancillary data (VANC)) embedded in the serial digital interface (SDI), among other possibilities.

The SCTE data could take the form of an extensible markup language (XML) data set and could include information such the start time and end time of an upcoming ad in the media stream, a universal program ID (UPID), advertisement ID (Ad-ID) or the like. Without limitation, for instance, where the SCTE data is included at or with a particular frame of the media stream, the SCTE data could have a pre-roll field that carries a frame-accurate indication of which upcoming frame (e.g., how many frames ahead) in the media stream is the start of the ad or that otherwise indicates the start time of the ad, and that specifies the ad's end or duration, as well as ad-identification information. Alternatively, other forms of such data could be provided in other ways.

SCTE data could be included in or with a media stream to enable MVPDs to carry out ad replacement, or for other purposes. For instance, a national broadcaster or other content provider could provide a packet-based transport stream that carries media stream including core program content and additionally including a commercial break defining a national ad. Further, per agreements with MVPDs, the national broadcaster could permit each MVPD to replace the included national ad with a local ad specific to the MVPD's market area. And to facilitate this, the national broadcaster could insert into the transport stream one or more SCTE packets or other such data that designate when the local ad replacement is to start and end. Other reasons for the presence of SCTE data could be possible as well.

In an example implementation of the present ad-harvesting process, as the reference-fingerprint-generation engine 208 generates reference fingerprints representing a media stream being distributed, the reference-fingerprint-generation engine 208 could also detect this SCTE data carried in or with the media stream. For instance, the reference-fingerprint-generation engine 208 could regularly monitor for the presence of SCTE data or the like, based on finding predefined SCTE data headers for instance, and could thereby detect the presence of the SCTE data.

In response to detecting the SCTE data, the reference-fingerprint-generation engine 208 could then obtain from the SCTE data the ad timing and identification information, and the reference-fingerprint-generation engine 208 could provide that obtained ad timing and identification information to the ad indexer 214, to enable the ad indexer to populate the ad-inventory database 212 with the associated set of reference fingerprints as the set of ad fingerprints representing the ad. (Alternatively, the reference-fingerprint-generation engine 208 itself could carry out this aspect of the process as well.)

The ad indexer 214 could then use the provided ad-timing information as a basis to identify from the established reference fingerprints the set of reference fingerprints that represent the ad. For instance, if the ad-timing information indicates the start and end frames and/or timestamps of the ad in the media stream, then the ad indexer 214 could determine the reference fingerprints representing the frames of the media stream from that start frame or time to that end frame or time to be the set of ad fingerprints representing the ad.

Given this determination, the ad indexer 214 could then write a copy of that set of reference fingerprints to the ad-inventory database 212 as the set of ad fingerprints representing the ad, along with associated ad-identification information and/or other metadata. For instance, the ad indexer 214 could obtain those very reference fingerprints from the reference-fingerprint database 210 and could store those obtained reference fingerprints in the ad-inventory database 212 as ad fingerprints along with metadata that associates the ad fingerprints with the ad that the fingerprints represent. Alternatively, the ad indexer 214 could record in the ad-inventory database 212 pointers to those reference fingerprints stored in the reference-fingerprint database 210, also along with associated metadata.

As noted above, the ad-metadata that the ad indexer 214 writes to the ad-inventory database in association with the ad fingerprints for this could come from the SCTE data or the like or could come from a program log or other data source. By way of example, the ad indexer 214 could read from the SCTE data the Ad-ID that identifies the ad, and the ad indexer could write that Ad-ID to the ad-inventory database in association with the ad fingerprints. Further, the ad indexer 214 could also receive in advance (e.g., daily) a programming schedule that indicates when particular ads are scheduled to appear in the media stream, keying each ad to the same Ad-ID used in the SCTE data, and that specifies for each ad various additional metadata. So the ad indexer 214 could additionally extract, from that programming schedule, additional metadata regarding the identified ad and could write that additional metadata to the ad-inventory database in association with the ad fingerprints.

As further noted above, a DAI system such as that described above could then make use of this information in the ad-inventory database 212 as a basis to later detect presence of another instance of the same ad in either the same media stream or another media stream being distributed, so as to trigger dynamic replacement of that later detected instance of the ad.

For example, if the computing system uses this process to populate the ad-inventory database 212 with ad fingerprints of an ad based on SCTE data or the like indicating presence of the ad in a given media stream being distributed by a given media distributor 202, the DAI system might then use those ad fingerprints as described above as a basis to detect the presence of the same ad later in that same media stream being distributed by the same media distributor 202, or as a basis to detect the presence of the same ad in another media stream being distributed by the same or another media distributor 202. And having detected the later presence of the ad, the DAI system may trigger server-side or client-side dynamic ad replacement to replace the ad with a replacement ad.

In an example implementation of this process, the computing system could determine in various ways whether an ad whose presence is indicated by SCTE data or the like is a replaceable ad, i.e., whether the ad is an ad that is subject to being replaced with another ad. Without limitation, for instance, ads for certain products or services, by certain advertisers, or having one or more other characteristics may be subject to dynamic ad replacement. So the computing system may determine based on ad-characteristic information included as part of the SCTE data and/or an associated programming-schedule, whether the ad at issue is a replaceable ad. And based on determining that the ad is a replaceable ad, the computing system could populate the ad-inventory database 212 with the associated ad fingerprints and metadata as described above. Whereas, if the computing system determines that the ad is not subject to replacement or does not determine that the ad is subject to replacement, then the computing system could forgo populating the ad-inventory database 212 with the associated ad fingerprints and metadata.

Note also that, while the present disclosure above focuses on implementation with respect to dynamic ad replacement, the disclosed principles could be extended to apply with respect to other types of content as well. For instance, rather than or in addition to addressing dynamic ad replacement, the described features could be implemented to more generally facilitate dynamic content modification, such as replacement of any replaceable segment of a media stream with a replacement media-content segment, or otherwise modifying of any modifiable-content segment of a media stream (e.g., superimposing video or audio content), among other possibilities. In these alternative implementations, the ad-inventory database 212 could be a modifiable-content-segment database and could be populated with fingerprints representing modifiable-content segments, not necessarily limited to ads, and the DAI server 206 and associated DAI engines 218, 220 could more generally be a dynamic-content-modification server and associated engines.

Further, note that alternatives to SCTE data could be used in the present process as well. For instance, the Advanced Television Systems Committee (ATSC) has likewise developed one or more standards that enable conveying of metadata in-band within a transport stream that carries a media stream from one entity to another. A recent example of such a standard is ATSC 3.0. In alternative implementations, ATSC data or other in-band data could demarcate the presence of an ad or other modifiable-content segment in a media stream being distributed, and the computing system could thus detect the presence of that in-band-demarcation data and use it as a basis to populate database 212 with corresponding fingerprints and associated metadata.

In addition, note that the computing system may need to wait for generation of the full set of reference fingerprints representing the replaceable ad or modifiable-content segment before then populating database 212 with those fingerprints and associated metadata. For instance, the reference-fingerprint-generation engine 208 may detect presence of the in-band demarcation data denoting presence and time position of an ad in the media stream and may inform the ad indexer 214 accordingly. But if that demarcation data appears in the media stream before or at the start of the ad and before the reference-fingerprint-generation engine 208 has generated reference fingerprints representing frames of the media stream through the ad, the ad indexer 214 may need to wait until those reference fingerprints are fully generated and stored before the ad indexer 214 populates the ad-inventory database 212 with those fingerprints as ad fingerprints. Alternatively, the ad indexer may populate the ad-inventory database 212 in parallel, i.e., concurrently with the reference-fingerprint-generation engine 208 generating the applicable reference fingerprints.

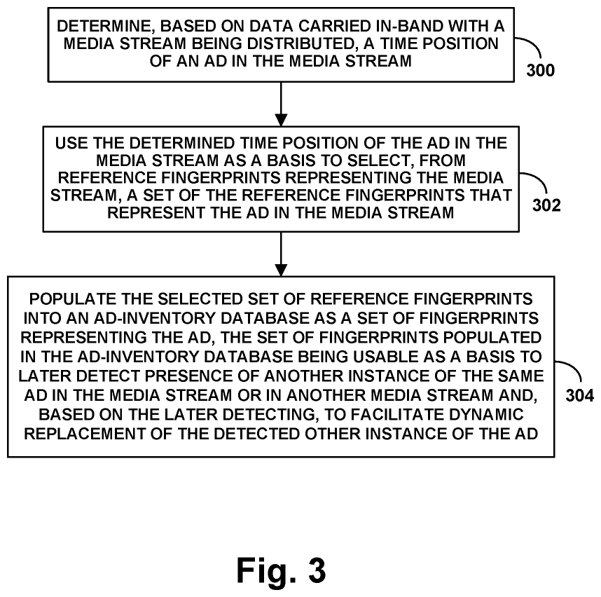

FIG. 3 is next a flow chart depicting an example method that can be carried out in accordance with the present disclosure. As shown in FIG. 3, at block 300, the method includes a computing system determining, based on data carried in-band with a media stream being distributed, a time position of an ad in the media stream. Further, at block 302, the method includes the computing system using the determined time position of the ad in the media stream as a basis to select, from reference fingerprints representing the media stream, a set of the reference fingerprints that represent the ad in the media stream. And at block 304, the method includes the computing system populating the selected set of reference fingerprints into an ad-inventory database as a set of fingerprints representing the ad, where the set of fingerprints populated in the ad-inventory database is usable as a basis to later detect presence of another instance of the same ad in the media stream or in another media stream and, based on the later detecting, to facilitate dynamic replacement of the detected other instance of the ad.

In line with the discussion above, the data carried in-band with the media stream being distributed could comprise SCTE data, among other possibilities.

Further, as discussed above, the data carried in-band with the media stream could indicate a starting time position of the ad in a timeline of the media stream and an ending time position of the ad in the timeline. For instance, the data could specify a frame timestamp of the first frame of the ad, and the data could specify a duration of the ad or a frame timestamp of a last frame of the ad. The act of selecting the set of reference fingerprints that represent the ad in the media stream could then involve selecting, as the set of reference fingerprints, reference fingerprints that represent frames of the media stream ranging from the indicated starting time position to the indicated ending time position.

In addition, as discussed above, the act of populating the selected set of reference fingerprints into the ad-inventory database as the set of fingerprints representing the ad could involve storing in the ad-inventory database, as the set of fingerprints representing the ad, the selected set of reference fingerprints. And the act of populating the selected set of reference fingerprints into the ad-inventory database as the set of fingerprints representing the ad could additionally include storing in the ad-inventory database, in association with the set of fingerprints representing the ad, metadata related to the ad, with the metadata including an identification of the ad.

Further, as discussed above, the method could include the computing system obtaining, from the data carried in-band with the media stream, at least a portion of the metadata to store in the ad-inventory database in association with the fingerprints representing the ad. And the method could include the computing system obtaining, from a programming schedule, at least a portion of the metadata to store in the ad-inventory database in association with the fingerprints representing the ad.

Still further, as discussed above, the method could include using the set of fingerprints populated in the ad-inventory database as the basis to later detect presence of the other instance of the same ad in the media stream or in the other media stream and, based on the later detecting, to facilitate the dynamic replacement of the detected other instance of the ad. And as discussed above, the dynamic replacement of the detected other instance of the ad could involve server-side dynamic ad replacement or client-side dynamic ad replacement.

Yet further, as discussed above, the method could include the computing system making a determination that the ad is a replaceable ad, and the computing system using that determination as a condition-precedent to at least the act of populating the selected set of reference fingerprints into the ad-inventory database as the set of fingerprints representing the ad.

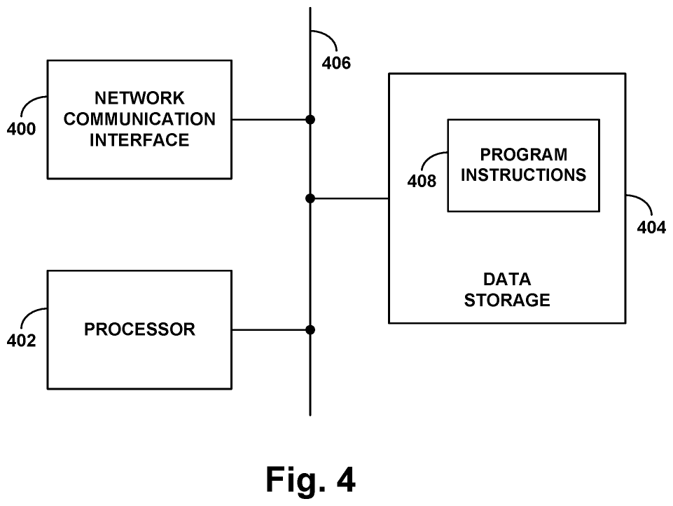

FIG. 4 is a simplified block diagram of an example computing system that could represent any of the various entities discussed above, alone or in combination. As shown in FIG. 4, the example computing system could include at least one network communication interface 400, at least one processor 402, and at least one instance of non-transitory data storage 404, any or all of which could be integrated together in various ways or, as shown, communicatively linked together by one or more system buses, networks, and/or other connection mechanisms 406.

Each network communication interface 400 could comprise one or more network connection mechanisms to facilitate communication on one or more networks, such as one or more LANs and/or one or more WANs, and/or for engaging in direct or networked communication with one or more other local or remote entities. As such, the network communication interface 400 could comprise a wireless or wired Ethernet interface or other type of network interface, for engaging in IP communication and/or other type of network communication, as well as network communication program logic for supporting such communication.

Each processor 402 could comprise one or more general purpose processors (e.g., microprocessors) and/or one or more specialized processors (e.g., application specific integrated circuits). And each instance of non-transitory data storage unit 404 could comprise one or more volatile and/or non-volatile storage components, such as optical, magnetic, or flash storage. As shown, the non-transitory data storage 404 could then store program instructions 408, which could be executable by any of the one or more processors 402 to carry out various operations described herein.

Various other features described herein could be implemented in this context as well, and vice versa.

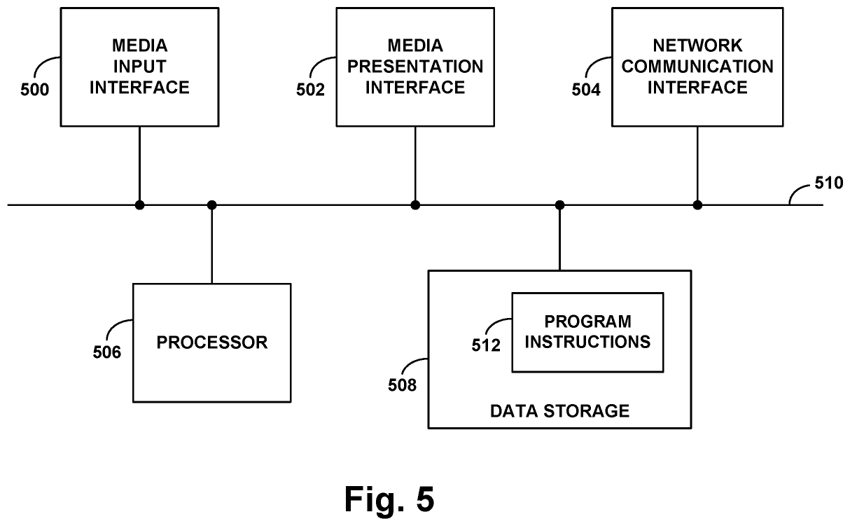

Finally, FIG. 5 is a simplified block diagram of an example media client. In line with the discussion above, this media client could take various forms noted above, among other possibilities. And as shown in FIG. 5, the example media client includes at least one media input interface 500, at least one media presentation interface 502, at least one network communication interface 504, at least one processor 506, and at least one non-transitory data storage 508, any or all of which could be integrated together or, as shown, communicatively linked together by a system bus, network, or other connection mechanism 510.

The at least one media input interface 500 could comprise a physical communication interface for receiving media content to be processed for presentation. As such, the at least one media input interface could include one or more wired and/or wireless interfaces for establishing communication with and receiving media content in analog or digital form from a receiver or other device or system. For example, a media input interface could include one or more interfaces compliant with protocols such as DVI, HDMI, VGA, USB, BLUETOOTH, WIFI, Ethernet, among numerous others.

The at least one media presentation interface 502 could then comprise one or more components to facilitate presentation of the received media content if applicable. By way of example, the at least one media presentation interface 502 could comprise a user interface such as a display screen, as well as one or more drivers or other components for processing the received media content to facilitate presentation of the content on the user interface.

The at least one network communication interface 504 could comprise a physical network connection mechanism to facilitate communication on one or more networks, and/or for engaging in direct or networked communication with one or more other local or remote entities. As such, the at least one network communication interface 504 could comprise a wireless or wired Ethernet interface or other type of network interface, for engaging in IP communication and/or other type of network communication.

Further, the at least one processor 506 could comprise one or more general purpose processors (e.g., microprocessors) and/or one or more specialized processors (e.g., application specific integrated circuits). And the at least one non-transitory data storage 508 could comprise one or more volatile and/or non-volatile storage components, such as optical, magnetic, or flash storage. Further, as shown, data storage 508 could store program instructions 512, which could be executable by at least one processor 506 to carry out various operations described herein.

Various other features described above could be implemented in this context as well, and vice versa.

The present disclosure also contemplates a non-transitory computer readable medium that is encoded with, stores, or otherwise embodies program instructions executable by one or more processors to carry out various described operations.

Exemplary embodiments have been described above. Those skilled in the art will understand, however, that changes and modifications may be made to these embodiments without departing from the true scope and spirit of the invention.

1. A method comprising:
determining, by a computing system, based on data carried in-band with a media stream being distributed, a time position of an ad in the media stream;
using, by the computing system, the determined time position of the ad in the media stream as a basis to select, from reference fingerprints representing the media stream, a set of the reference fingerprints that represent the ad in the media stream, wherein the data carried in-band with the media stream indicates a starting time position of the ad in a timeline of the media stream and an ending time position of the ad in the timeline, and wherein selecting the set of reference fingerprints that represent the ad in the media stream comprises selecting, as the set of reference fingerprints, reference fingerprints that represent frames of the media stream ranging from the indicated starting time position to the indicated ending time position; and
populating, by the computing system, the selected set of reference fingerprints into an ad-inventory database as a set of fingerprints representing the ad, wherein the set of fingerprints populated in the ad-inventory database is usable as a basis to later detect presence of another instance of the same ad in the media stream or in another media stream and, based on the later detecting, to facilitate dynamic replacement of the detected other instance of the ad.

2. The method of claim 1, wherein the data carried in-band with the media stream being distributed comprises Society of Cable and Telecommunications Engineers (SCTE) data.

3. (canceled)

4. The method of claim 1, wherein populating the selected set of reference fingerprints into the ad-inventory database as the set of fingerprints representing the ad comprises storing in the ad-inventory database, as the set of fingerprints representing the ad, the selected set of reference fingerprints.

5. The method of claim 4, wherein populating the selected set of reference fingerprints into the ad-inventory database as the set of fingerprints representing the ad further comprises storing in the ad-inventory database, in association with the set of fingerprints representing the ad, metadata related to the ad, wherein the metadata includes an identification of the ad.

6. The method of claim 5, further comprising obtaining, by the computing system, from the data carried in-band with the media stream, at least a portion of the metadata to store in the ad-inventory database in association with the fingerprints representing the ad.

7. The method of claim 5, further comprising obtaining, by the computing system, from a programming schedule, at least a portion of the metadata to store in the ad-inventory database in association with the fingerprints representing the ad.

8. The method of claim 1, further comprising using the set of fingerprints populated in the ad-inventory database as the basis to later detect presence of the other instance of the same ad in the media stream or in the other media stream and, based on the later detecting, to facilitate the dynamic replacement of the detected other instance of the ad.

9. The method of claim 8, wherein the dynamic replacement of the detected other instance of the ad comprises server-side dynamic ad replacement.

10. The method of claim 8, wherein the dynamic replacement of the detected other instance of the ad comprises client-side dynamic ad replacement.

11. The method of claim 1, further comprising making a determination, by the computing system, that the ad is a replaceable ad, and using, by the computing system, the determination as a condition-precedent to at least the populating.

12. A computing system comprising:
at least one processor;
at least one non-transitory data storage; and
program instructions stored in the at least one non-transitory data storage and executable by the at least one processor to carry out operations including:
determining, based on data carried in-band with a media stream being distributed, a time position of an ad in the media stream,
using the determined time position of the ad in the media stream as a basis to select, from reference fingerprints representing the media stream, a set of the reference fingerprints that represent the ad in the media stream, wherein the data carried in-band with the media stream indicates a starting time position of the ad in a timeline of the media stream and an ending time position of the ad in the timeline, and wherein selecting the set of reference fingerprints that represent the ad in the media stream comprises selecting, as the set of reference fingerprints, reference fingerprints that represent frames of the media stream ranging from the indicated starting time position to the indicated ending time position, and
populating the selected set of reference fingerprints into an ad-inventory database as a set of fingerprints representing the ad, wherein the set of fingerprints populated in the ad-inventory database is usable as a basis to later detect presence of another instance of the same ad in the media stream or in another media stream and, based on the later detecting, to facilitate dynamic replacement of the detected other instance of the ad.

13. The computing system of claim 12, wherein the data carried in-band with the media stream being distributed comprises Society of Cable and Telecommunications Engineers (SCTE) data.

14. (canceled)

15. The computing system of claim 12, wherein populating the selected set of reference fingerprints into the ad-inventory database as the set of fingerprints representing the ad comprises storing in the ad-inventory database, as the set of fingerprints representing the ad, the selected set of reference fingerprints.

16. The computing system of claim 15, wherein populating the selected set of reference fingerprints into the ad-inventory database as the set of fingerprints representing the ad further comprises storing in the ad-inventory database, in association with the set of fingerprints representing the ad, metadata related to the ad, wherein the metadata includes an identification of the ad.

17. The computing system of claim 16, wherein the operations additionally include obtaining, from the data carried in-band with the media stream, at least a portion of the metadata to store in the ad-inventory database in association with the fingerprints representing the ad.

18. The computing system of claim 16, wherein the operations additionally include obtaining, from a programming schedule, at least a portion of the metadata to store in the ad-inventory database in association with the fingerprints representing the ad.

19. The computing system of claim 12, wherein the operations additionally include making a determination, that the ad is a replaceable ad, and using the determination as a condition-precedent to at least the populating.

20. At least one non-transitory computer-readable medium embodying program instructions executable by at least one processor to carry out operations comprising:
determining based on data carried in-band with a media stream being distributed, a time position of an ad in the media stream;
using the determined time position of the ad in the media stream as a basis to select, from reference fingerprints representing the media stream, a set of the reference fingerprints that represent the ad in the media stream, wherein the data carried in-band with the media stream indicates a starting time position of the ad in a timeline of the media stream and an ending time position of the ad in the timeline, and wherein selecting the set of reference fingerprints that represent the ad in the media stream comprises selecting, as the set of reference fingerprints, reference fingerprints that represent frames of the media stream ranging from the indicated starting time position to the indicated ending time position; and
populating the selected set of reference fingerprints into an ad-inventory database as a set of fingerprints representing the ad, wherein the set of fingerprints populated in the ad-inventory database is usable as a basis to later detect presence of another instance of the same ad in the media stream or in another media stream and, based on the later detecting, to facilitate dynamic replacement of the detected other instance of the ad.
